(19) United States
(12) Patent Application Publication
(10) Pub. No.: US 2020/0193710 A1
(43) Pub. Date: Jun. 18, 2020

(54) RENDERING VISUAL REPRESENTATIONS IN AN AUGMENTED AND/OR VIRTUAL REALITY ENVIRONMENT

(71) Applicant: KONINKLIJKE PHILIPS N.V., EINDHOVEN (NL)

(72) Inventors: ELISE CLAUDE VALENTINE TALGORN, EINDHOVEN (NL); LUCAS JACOBUS FRANCISCUS GEURTS, BEST (NL); OMNA TOSHNIWAL, EINDHOVEN (NL); ATIKE DICLE PEKEL, EINDHOVEN (NL)

(21) Appl. No.: 16/707,787

(22) Filed: Dec. 9, 2019

Related U.S. Application Data
(60) Provisional application No. 62/778,407, filed on Dec. 12, 2018.

(51) Int. Cl. G06T 19/00; G06T 19/20; G06T 15/08

(52) U.S. Cl. CPC G06T 19/006; G06T 15/08; G06T 19/20

(57) ABSTRACT

There is provided an apparatus (100) for rendering one or more visual representations in an augmented and/or virtual reality environment. The apparatus (100) comprises a processor (102) configured to determine a first distance from a proximal end of a limb or part of the limb of a user to a first body part located at a distal end of the limb or part of the limb of the user. The processor is further configured to define a first surface in the augmented and/or virtual reality environment at the determined first distance. The first surface is defined by a rotation at a joint located at the proximal end or the distal end of the limb or part of the limb of the user. The processor is also configured to render a visual representation at a first position on the defined first surface in the augmented and/or virtual reality environment.

### FIELD OF THE INVENTION

The disclosure relates to an apparatus, a method and a computer program product for rendering one or more visual representations in an augmented and/or virtual reality environment.

### BACKGROUND OF THE INVENTION

Virtual reality (VR) environments, augmented reality (AR) environments, and combined VR and AR environments (also known as mixed reality (MR) environments) are becoming increasing popular due to technological advancements.

In some existing techniques, virtual objects are located far away from a user in the VR, AR or MR environment. For example, virtual objects can appear as if they are floating in air at a given distance from the user. In these techniques, the user interacts with virtual objects in the distance by adjusting a position of a hand gesture or a handheld pointer to align with the position of the virtual object. The issue with this is that the hand gesture or the handheld pointer needs to be aligned accurately enough to catch the distant virtual object and this inevitably slows down the interaction with the virtual object, since even a small deviation in angle of the hand gesture or handheld pointer has a large effect on a targeted position at a large distance.

In some other existing techniques, virtual objects are located close to a user in the VR, AR or MR environment. In these techniques, the user interacts with virtual objects by moving their hand to the virtual objects and then performing a hand gesture on them. The user can, for example, use a pinch gesture to move the virtual objects farther away. The issue with this is that the user is unsure at what distance the virtual objects are located, since there is no haptic feedback. This results in the user extending their arm too far such that their hand is seen to go through the virtual object.

The idea of including a physical object (e.g. a transparent wall) in the environment for the user to know that they are to stand a certain distance from that physical object to interact with a virtual object has been considered. However, this imposes undesirable physical constraints on the VR, AR or MR environment.

### SUMMARY OF THE INVENTION

As noted above, a limitation associated with existing techniques is that virtual objects are either placed too far away from the user or too close to the user for the user to interact with the virtual objects easily and efficiently. It would thus be valuable to provide an improved technique aimed at addressing this limitation.

Therefore, according to a first aspect, there is provided an apparatus for rendering one or more visual representations in an augmented and/or virtual reality environment. The apparatus comprises a processor configured to determine a first distance from a proximal end of a limb or a part of the limb of a user to a first body part located at a distal end of the limb or the part of the limb of the user. The processor is further configured to define a first surface in the augmented and/or virtual reality environment at the determined first distance. The first surface is defined by a rotation at a joint located at the proximal end or the distal end of the limb or the part of the limb of the user. The processor is also configured to render a visual representation at a first position on the defined first surface in the augmented and/or virtual reality environment.

In some embodiments, the limb may be an arm of the user, the first body part located at the distal end of the limb may be a palm of a hand of the user or a fingertip of the hand of the user and the joint may comprise a shoulder joint of the user or a wrist joint of the user. In some embodiments, the part of the limb may be a forearm of the user, the first body part located at the distal end of the part of the limb may be a palm of a hand of the user or a fingertip of the hand of the user and the joint may comprise an elbow joint of the user or a wrist joint of the user. In some embodiments, the limb may be a leg of the user, the first body part located at the distal end of the limb may be a sole of a foot of the user or a toe tip of the foot of the user and the joint may comprise a hip joint of the user or an ankle joint of the user. In some embodiments, the part of the limb may be a lower leg of the user, the first body part located at the distal end of the part of the limb may be a sole of a foot of the user or a toe tip of the foot of the user and the joint may comprise a knee joint of the user or an ankle joint of the user.

In some embodiments, the rotation at the joint may be detected by a sensor. In some embodiments, the processor may be configured to determine the first distance by being configured to measure a straight line from the proximal end of the limb or the part of the limb of the user to the first body part located at the distal end of the limb or the part of the limb of the user. In some embodiments, the processor may be configured to determine the first distance by being configured to measure an angle at a plurality of joints along the limb or the part of the limb of the user. In some embodiments, the processor may be configured to determine the first distance by being configured to measure a position of the first body part located at the distal end of the limb or the part of the limb of the user.

In some embodiments, the processor may be configured to detect a motion gesture of the user. In some of these embodiments, a body part used for the detected motion gesture of the user may be the first body part located at the distal end of the limb or the part of the limb. In some embodiments, the first surface may exclude a portion that is unreachable by the rotation. In some embodiments, the processor may be configured to render the visual representation by being configured to render a front surface of the visual representation tangential to the defined first surface in the augmented and/or virtual reality environment.

In some embodiments, the processor may be configured to determine the first distance and define the first surface for at least two limbs or at least two parts of the limbs of the user and render the visual representation at a first position on at least one of the defined first surfaces in the augmented and/or virtual reality environment. In some embodiments, the processor may be configured to receive an input to displace the rendered visual representation from the first position on the defined first surface to a subsequent position in the augmented and/or virtual reality environment and render the visual representation at the subsequent position.

In some embodiments, the processor may be configured to determine a second distance from the proximal end of the limb or the part of the limb of the user to a second body part located at the distal end of the limb or the part of the limb of the user, wherein the second distance may be less than the first distance. In some of these embodiments, the processor may be configured to define a second surface in the augmented and/or virtual reality environment at the determined second distance, wherein the second surface may be defined by the rotation at the joint located at the proximal end of the limb or the part of the limb of the user or distal end of the limb or the part of the limb of the user. In some of these embodiments, the processor may be configured to render at least one other visual representation at a second position on the defined second surface in the augmented and/or virtual reality environment.

In some embodiments, the limb may be an arm of the user, the second body part located at distal end of the limb may comprise a wrist joint of the user and the joint may comprise a shoulder joint of the user or the wrist joint of the user. In some embodiments, the part of the limb may be a forearm of the user, the second body part located at distal end of the part of the limb may comprise a wrist joint of the user and the joint may comprise an elbow joint of the user or the wrist joint of the user. In some embodiments, the limb may be a leg of the user, the second body part located at distal end of the limb may comprise an ankle joint of the user and the joint may comprise a hip joint of the user or the ankle joint of the user. In some embodiments, the part of the limb may be a lower leg of the user, the second body part located at distal end of the part of the limb may comprise an ankle joint of the user and the joint may comprise a knee joint of the user or the ankle joint of the user.

In some embodiments, the processor may be configured to determine a third distance from the proximal end of the limb or the part of the limb of the user, wherein the third distance may be the first distance plus a predefined additional distance. In some of these embodiments, the processor may be configured to define a third surface in the augmented and/or virtual reality environment at the determined third distance, wherein the third surface may be defined by the rotation at the joint located at the proximal end of the limb or the part of the limb of the user or distal end of the limb or the part of the limb of the user. In some of these embodiments, the processor may be configured to render at least one other visual representation at a third position on the defined third surface in the augmented and/or virtual reality environment.

In some embodiments, the visual representation may comprise any one or more of a one dimensional visual representation, a two dimensional visual representation, and a three dimensional visual representation.

According to a second aspect, there is provided a computer-implemented method for rendering one or more visual representations in an augmented and/or virtual reality environment. The method comprises determining a first distance from a proximal end of a limb or a part of the limb of a user to a first body part located at a distal end of the limb or the part of the limb of the user. The method further comprises defining a first surface in the augmented and/or virtual reality environment at the determined first distance. The first surface is defined by a rotation at a joint located at the proximal end or the distal end of the limb or the part of the limb of the user. The method also comprises rendering a visual representation at a first position on the defined first surface in the augmented and/or virtual reality environment.

According to a third aspect, there is provided a computer program product comprising a non-transitory computer readable medium. The computer readable medium has computer readable code embodied therein. The computer readable code is configured such that, on execution by a suitable computer or processor, the computer or processor is caused to perform the method as described above.

According to the aspects and embodiments described above, the limitation of the existing technique is addressed. In particular, the above-described aspects and embodiments enable a visual representation to be rendered at the optimum (or ideal) distance from the user. More specifically, the visual representation is rendered just within the physical reach of the user. This eliminates the need for a physical object (e.g. a transparent wall) to aid the user in deciding where to position themselves to interact with the visual representation, since the surface on which the visual representation is rendered is at the determined distance from the proximal end of the limb (or the part of the limb) of the user to the first body part located at the distal end of the limb (or the part of the limb) of the user and thus the visual representation is initially rendered at the optimum distance from the user irrespective of their location within the augmented and/or virtual reality environment.

The visual representation is rendered at an initial position in the augmented and/or virtual reality environment that is most favorable for ergonomics and usability (e.g. a position at a fully extended arm length or a position at a resting arm length). This simplifies and speeds up the initial interaction of the user with the visual representation, thereby making the interaction more intuitive and efficient. Moreover, since the surface on which the visual representation is rendered is at the determined distance from the proximal end of the limb (or the part of the limb) of the user to the first body part located at the distal end of the limb (or the part of the limb) of the user, the position at the visual representation is rendered is customized for each user.

The limitations associated with the existing techniques discussed earlier are therefore addressed by way of the above-described aspects and embodiments.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 is a block diagram of an apparatus according to an embodiment;

FIG. 2 is a flowchart of a method according to an embodiment;

FIG. 3 is a schematic illustration of an augmented and/or virtual reality environment according to an embodiment; and

FIG. 4 is a schematic illustration of an augmented and/or virtual reality environment according to another embodiment.

### DETAILED DESCRIPTION OF EMBODIMENTS

As noted above, there is provided herein an apparatus, method and computer program product for rendering a visual (or virtual) representation in an augmented and/or virtual reality environment, which is aimed at overcoming existing problems. The apparatus, method and computer program product described herein can be for rendering one visual representation or a plurality of visual representations (i.e. one or more visual representations) in the augmented and/or virtual reality environment. A visual representation can, for example, comprise any one or more of a one dimensional (1D) visual representation, a two dimensional (2D) visual representation, a three dimensional (3D) visual representation, and any other dimensional visual representation. Examples of a visual representation include, but are not limited to, a pointer, a window (e.g. a viewing area from a graphical user interface (GUI)), an object (e.g. a dynamic object), a button, or any other visual representation, or any other visual representation, or any combination of visual representations.

A virtual reality (VR) environment is an artificial digital environment. For example, a VR environment may be a computer-generated simulation or a recreation of a real world (or real life) environment. A VR environment shuts out the real world environment, such that the user is fully immersed in the VR environment. In a VR environment, visual representations are provided in the artificial environment. On the other hand, an augmented reality (AR) environment is a real world (or real life) environment. For example, an AR environment may be a view of a real world environment through a camera, such as a camera on a mobile device (e.g. a smartphone, a tablet, etc.). In an AR environment, visual representations are overlaid in the real world environment without being anchored to a point in the real world. A virtual and augmented environment is an environment that combines aspects of the VR environment and the AR environment. A virtual and augmented environment may also be referred to as a mixed reality (MR) environment. Like an AR environment, an MR environment is a real world environment. In an MR environment, visual representations are overlaid in the real world environment (as in an AR environment) but the visual representations are also anchored to a point in the real world. In this way, the visual representations appear as if they are actually part of the real world.

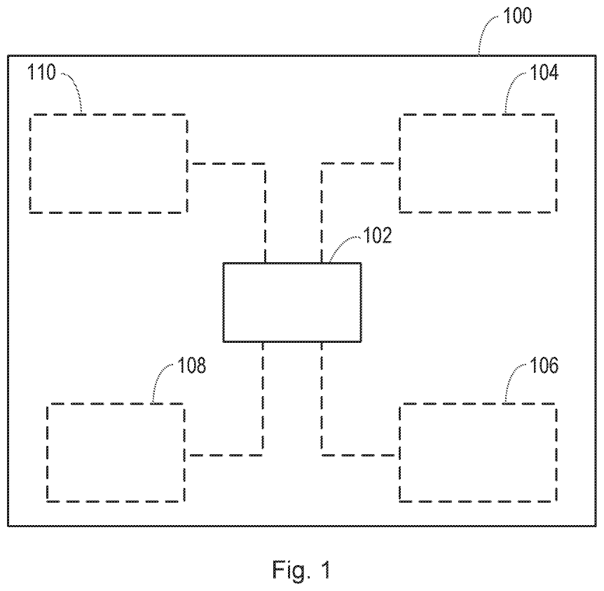

FIG. 1 illustrates an apparatus 100 for rendering one or more visual (or virtual) representations in an augmented and/or virtual reality environment according to an embodiment. As illustrated in FIG. 1, the apparatus 100 comprises a processor 102. Briefly, the processor 102 of the apparatus 100 is configured to determine a first distance from a proximal end of a limb (or a part of the limb) of a user to a first body part located at a distal end of the limb (or the part of the limb) of the user and define a first surface in the augmented and/or virtual reality environment at the determined first distance. The first surface is defined by a rotation at a joint located at the proximal end or the distal end of the limb (or the part of the limb) of the user. The processor 102 of the apparatus 100 is also configured to render a first visual (or virtual) representation at a first position on the defined first surface in the augmented and/or virtual reality environment.

In some embodiments, the apparatus 100 may be incorporated into an operating system (OS), or other middleware, application programming interface (API). In some of these embodiments, an application may provide the first visual representation to be rendered and the apparatus 100 of the OS (or other middleware) API can be configured to operate in the manner described herein to render the first visual representation at the first position on the defined first surface in the augmented and/or virtual reality environment, optionally also with a callback to the application.

In some embodiments, the processor 102 of the apparatus 100 may comprise one or more processors 102. The one or more processors 102 can be implemented in numerous ways, with software and/or hardware, to perform the various functions described herein. In some embodiments, each of the one or more processors 102 can be configured to perform individual or multiple steps of the method described herein. In particular implementations, the one or more processors 102 can comprise a plurality of software and/or hardware modules, each configured to perform, or that are for performing, individual or multiple steps of the method described herein.

The one or more processors 102 may comprise one or more microprocessors, one or more multi-core processors and/or one or more digital signal processors (DSPs), one or more processing units, and/or one or more controllers (such as one or more microcontrollers) that may be configured or programmed (e.g. using software or computer program code) to perform the various functions described herein. The one or more processors 102 may be implemented as a combination of dedicated hardware (e.g. amplifiers, pre-amplifiers, analog-to-digital convertors (ADCs) and/or digital-to-analog convertors (DACs)) to perform some functions and one or more processors (e.g. one or more programmed microprocessors, DSPs and associated circuitry) to perform other functions.

As illustrated in FIG. 1, in some embodiments, the apparatus 100 may comprise a sensor 104. However, it will be understood that, in other embodiments, the sensor 104 may be external to (i.e. separate to or remote from) the apparatus 100. For example, in some embodiments, the sensor 104 can be a separate entity or part of another apparatus (e.g. a device). The sensor 104 can be configured to detect the rotation at the joint.

As illustrated in FIG. 1, in some embodiments, the apparatus 100 may comprise a memory 106. Alternatively, or in addition, the memory 106 may be external to (e.g. separate to or remote from) the apparatus 100. The processor 102 of the apparatus 100 may be configured to communicate with and/or connect to the memory 106. The memory 106 may comprise any type of non-transitory machine-readable medium, such as cache or system memory including volatile and non-volatile computer memory such as random-access memory (RAM), static RAM (SRAM), dynamic RAM (DRAM), read-only memory (ROM), programmable ROM (PROM), erasable PROM (EPROM), and electrically erasable PROM (EEPROM). In some embodiments, the memory 106 can be configured to store program code that can be executed by the processor 102 to cause the apparatus 100 to operate in the manner described herein. In some embodiments, the memory 106 may comprise instruction data representing a set of instructions. In some of these embodiments, the processor 102 may be configured to communicate with the memory 106 and to execute the set of instructions. The set of instructions, when executed by the processor 102, may cause the processor 102 to operate in the manner described herein.

Alternatively, or in addition, in some embodiments, the memory 106 can be configured to store information required by or resulting from the method described herein. For example, in some embodiments, the memory 106 may be configured to store any one or more of the determined first distance, any other determined distances described herein, the defined first surface, any other defined surfaces described herein, the first visual representation, any other visual representations described herein, or any other information, or any combination of information, required by or resulting from the method described herein. In some embodiments, the processor 102 of the apparatus 100 can be configured to control the memory 106 to store information required by or resulting from the method described herein.

As also illustrated in FIG. 1, in some embodiments, the apparatus 100 may comprise a communications interface (or communications circuitry) 108. Alternatively, or in addition, the communications interface 108 may be external to (e.g. separate to or remote from) the apparatus 100. The communications interface 108 can be for enabling the apparatus 100, or components of the apparatus 100, to communicate with and/or connect to one or more other components, sensors, interfaces, devices, or memories (such as any of those described herein). For example, the communications interface 108 can be for enabling the processor 102 of the apparatus 100 to communicate with and/or connect to the sensor 104 and/or memory 106 described earlier. The communications interface 108 may enable the apparatus 100, or components of the apparatus 100, to communicate and/or connect in any suitable way. For example, the communications interface 108 may enable the apparatus 100, or components of the apparatus 100, to communicate and/or connect wirelessly, via a wired connection, or via any other communication (or data transfer) mechanism. In some wireless embodiments, for example, the communications interface 108 may enable the apparatus 100, or components of the apparatus 100, to use radio frequency (RF), Bluetooth, or any other wireless communication technology to communicate and/or connect.

As illustrated in FIG. 1, in some embodiments, the apparatus 100 may comprise a user interface 110. Alternatively, or in addition, the user interface 110 may be external to (e.g. separate to or remote from) the apparatus 100. The processor 102 of the apparatus 100 may be configured to communicate with and/or connect to a user interface 110. The user interface 110 can be configured to render (e.g. output, display, or provide) information required by or resulting from the method described herein. For example, in some embodiments, the user interface 110 may be configured to render (e.g. output, display, or provide) any one or more of the determined first distance, any other determined distances described herein, the defined first surface, any other defined surfaces described herein, the first visual representation, any other visual representations described herein, or any other information, or any combination of information, required by or resulting from the method described herein. Alternatively, or in addition, the user interface 110 can be configured to receive a user input. For example, the user interface 110 may allow a user to manually enter information or instructions, interact with and/or control the apparatus 100. Thus, the user interface 110 may be any user interface that enables the rendering (or outputting, displaying, or providing) of information and, alternatively or in addition, enables a user to provide a user input. In some embodiments, the processor 102 of the apparatus 100 can be configured to control the user interface 110 to operate in the manner described herein.

For example, the user interface 110 may comprise one or more switches, one or more buttons, a keypad, a keyboard, a mouse, a touch screen or an application (e.g. on a smart device such as a tablet, a smartphone, smartwatch, or any other smart device), a controller (e.g. a game controller or a virtual reality controller), a motion tracker, a glove (e.g. a virtual reality glove), a display or display screen, a graphical user interface (GUI) such as a touch screen, or any other visual component, one or more speakers, one or more microphones or any other audio component, one or more lights (e.g. light emitting diode LED lights), a component for providing tactile or haptic feedback (e.g. a vibration function, or any other tactile feedback component), an augmented, virtual or mixed reality device (e.g. augmented, virtual or mixed reality glasses, or any other augmented, virtual or mixed reality device), a smart device (e.g. a smart mirror, a tablet, a smart phone, a smart watch, or any other smart device), or any other user interface, or combination of user interfaces. In some embodiments, the user interface that is controlled to render information may be the same user interface as that which enables the user to provide a user input.

Although not illustrated in FIG. 1, the apparatus 100 may comprise a battery or other power supply for powering the apparatus 100 or means for connecting the apparatus 100 to a mains power supply. It will also be understood that the apparatus 100 may comprise any other component to those described herein or any combination of components.

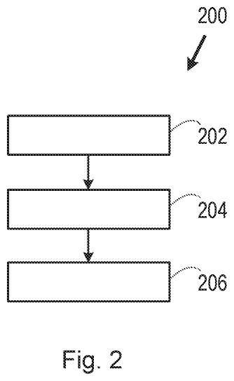

FIG. 2 illustrates a computer-implemented method 200 for rendering one or more visual representations in an augmented and/or virtual reality environment. More specifically, FIG. 2 illustrates a computer-implemented method 200 of operating the apparatus 100 described earlier for rendering one or more visual representations in an augmented and/or virtual reality environment. As described earlier, the apparatus 100 comprises a processor 102. The method 200 illustrated in FIG. 2 can generally be performed by or under the control of the processor 102 of the apparatus 100.

With reference to FIG. 2, at block 202 of FIG. 2, a first distance from a proximal end of a limb (or a part of the limb) of a user to a first body part located at a distal end of the limb (or the part of the limb) of the user is determined. More specifically, the processor 102 of the apparatus 100 determines the first distance from the proximal end of the limb of the user to the first body part located at the distal end of the limb (or the part of the limb) of the user. The limb of the user may be fully extended, in a resting position (e.g. at least partially bent), or stretched out (beyond a natural fully extended position). In some embodiments, it may be determined in a calibration step whether the limb of the user is fully extended, in a resting position, or stretched out, e.g. by asking the user to perform rotation of the first body part in the most natural or relaxed manner or by measuring the muscle strength(s) in the limb. A person skilled in the art will be aware of various techniques and sensors that can be used to measure the muscle strength(s) in the limb.

In some embodiments, the limb may be an arm of the user and the first body part located at the distal end of the limb may be a palm of a hand of the user or a fingertip of the hand of the user. Thus, in some embodiments, the first distance can be from a proximal end of an arm of the user to a palm of a hand located at a distal end of the arm of the user or from the proximal end of the arm of the user to a fingertip of the hand located at the distal end of the arm of the user. In some embodiments, the part of the limb may be a forearm of the user and the first body part located at the distal end of the part of the limb may be a palm of a hand of the user or a fingertip of the hand of the user. Thus, in some embodiments, the first distance can be from a proximal end of a forearm of the user to a palm of a hand located at a distal end of the forearm of the user or from a proximal end of the forearm of the user to a fingertip of the hand located at the distal end of the forearm of the user.

In some embodiments, the limb (e.g. the leg) of the user may be used when the user is detected to be in a standing position, whereas the part of the limb (e.g. the lower leg) of the user may be used when the user is detected to be in a sitting position. In some of these embodiments, for example, the processor 102 can be configured to process data obtained by the sensor 104 to detect whether the user is in a standing position or a sitting position. For example, in some embodiments, the sensor 104 may comprise a camera (e.g. a three dimensional camera) and the processor 102 can be configured to process data obtained by the camera to determine whether the user is in a standing position or a sitting position.

In some embodiments, where it is intended for a user to use an initial volumetric gesture (e.g. a grabbing gesture, a holding gesture, or any other volumetric gesture) to interact with a visual representation, the first distance may be from the proximal end of the arm (or the part of the arm) of the user to the palm of a hand located at the distal end of the arm (or the part of the arm) of the user. In other embodiments, where it is intended for a user to use an initial superficial gesture (e.g. a pointing gesture, a sweeping gesture, or any other superficial gesture) to interact with a visual representation, the first distance may be from the proximal end of the arm (or the part of the arm) of the user to the fingertip of the hand located at the distal end of the arm (or the part of the arm) of the user.

In some embodiments, the limb may be a leg of the user and the first body part located at the distal end of the limb may be a sole of a foot of the user or a toe tip of the foot of the user. Thus, in some embodiments, the first distance can be from a proximal end of a leg of the user to a sole of a foot located at a distal end of the leg of the user or from the proximal end of the leg of the user to a toe tip of the foot located at the distal end of the leg of the user. In some embodiments, the part of the limb may be a lower leg of the user and the first body part located at the distal end of the part of the limb may be a sole of a foot of the user or a toe tip of the foot of the user. Thus, in some embodiments, the first distance can be from a proximal end of a lower leg of the user to a sole of a foot located at a distal end of the lower leg of the user or from the proximal end of the lower leg of the user to a toe tip of the foot located at the distal end of the lower leg of the user.

In some embodiments (e.g. where the limb of the user is fully extended), the processor 102 can be configured to determine the first distance by being configured to measure a straight line from the proximal end of the limb (or the part of the limb) of the user to the first body part located at the distal end of the limb (or the part of the limb) of the user. For example, in embodiments where the limb is an arm of the user and the first body part located at the distal end of the limb is a palm of a hand of the user or a fingertip of the hand of the user, the processor 102 can be configured to determine the first distance by being configured to measure a straight line from the proximal end of the arm of the user to the palm of the hand located at the distal end of the arm or the fingertip of the hand located at the distal end of the arm. In embodiments where the part of the limb is a forearm of the user and the first body part located at the distal end of the part of the limb is a palm of a hand of the user or a fingertip of the hand of the user, the processor 102 can be configured to determine the first distance by being configured to measure a straight line from the proximal end of the forearm of the user to the palm of the hand located at the distal end of the forearm or the fingertip of the hand located at the distal end of the forearm.

Similarly, for example, in embodiments where the limb is a leg of the user and the first body part located at the distal end of the limb is a sole of a foot of the user or a toe tip of the foot of the user, the processor 102 can be configured to determine the first distance by being configured to measure a straight line from the proximal end of the leg of the user to the sole of the foot located at the distal end of the leg or the toe tip of the foot located at the distal end of the leg. In embodiments where the part of the limb is a lower leg of the user and the first body part located at the distal end of the part of the limb is a sole of a foot of the user or a toe tip of the foot of the user, the processor 102 can be configured to determine the first distance by being configured to measure a straight line from the proximal end of the lower leg of the user to the sole of the foot located at the distal end of the lower leg or the toe tip of the foot located at the distal end of the lower leg.

Alternatively or in addition, in some embodiments (e.g. where the limb of the user is in a resting position, such as where the limb of the user is at least partially bent), the processor 102 can be configured to determine the first distance by being configured to measure an angle at a plurality of joints along the limb (or the part of the limb) of the user. In embodiments where the limb is an arm of the user, for example, the one or more joints along the limb of the user may be any one or more of the shoulder joint, the elbow joint, and the wrist joint. In embodiments where the part of the limb is a forearm of the user, for example, the one or more joints along the part of the limb of the user may be any one or more of the elbow joint and the wrist joint. Similarly, in embodiments where the limb is a leg of the user, for example, the one or more joints along the limb of the user may be any one or more of the hip joint, the knee joint, and the ankle joint. In embodiments where the part of the limb is a lower leg of the user, for example, the one or more joints along the part of the limb of the user may be any one or more of the knee joint and the ankle joint.

In some embodiments, the first distance may be determined by measuring an angle at a plurality of joints along the limb of the user and the lengths of the parts of the limb of the user (e.g. the lengths of the forearm and upper arm where the limb is an arm or the lengths of the lower leg and upper leg where the limb is a leg) and using geometric formulas. For example, the geometric formulas may be the law of cosines. A person skilled in the art will be aware of the manner in which the first distance may be determined using such geometric formulas. In some embodiments, an angle at a plurality of joints along the limb (or the part of the limb) of the user may be taken into account in the measurement of the first distance where the posture of the user changes, e.g. where a posture of the user becomes uncomfortable or the user loses balance.

Alternatively or in addition, in some embodiments, the processor 102 can be configured to determine the first distance by being configured to measure a position of the first body part located at the distal end of the limb (or the part of the limb) of the user. As mentioned earlier, where the limb is an arm (or the part of the limb is a forearm) of the user, the first body part located at the distal end of the limb (or the part of the limb) may be a palm of a hand of the user or a fingertip of the hand of the user. Thus, in some embodiments, the processor 102 can be configured to determine the first distance by being configured to measure a position of the palm of a hand located at the distal end of the arm (or the forearm) or a fingertip of the hand located at the distal end of the arm (or the forearm). As also mentioned earlier, where the limb is a leg (or the part of the limb is a lower leg) of the user, the first body part located at the distal end of the limb (or the part of the limb) may be a sole of a foot of the user or a toe tip of the foot of the user. Thus, in some embodiments, the processor 102 can be configured to determine the first distance by being configured to measure a position of the foot located at the distal end of the leg (or the lower leg) or the toe tip of the foot located at the distal end of the leg (or the lower leg).

A person skilled in the art will be aware of various mechanisms by which the first distance can be determined. That is, for example, a person skilled in the art will be aware of various mechanisms by which a straight line from the proximal end of the limb (or the part of the limb) of the user to the first body part located at the distal end of the limb (or the part of the limb) of the user can be measured, an angle at a plurality of joints along the limb (or the part of the limb) of the user can be measured, and/or a position of the first body part located at the distal end of the limb (or the part of the limb) of the user can be measured.

In some embodiments, for example, the processor 102 can be configured to process data obtained by the sensor 104 to determine the first distance. For example, in some embodiments, the sensor 104 may comprise a camera (e.g. a three dimensional camera) and the processor 102 can be configured to process data obtained by the camera to determine the first distance, such as by a skeleton recognition technique. For example, in some embodiments, the camera may be used to project structured light onto the user for the locations of the joints along the limb (or the part of the limb) of the user to be determined. From the locations of the joints, the angles and lengths of the parts of the limb of the user mentioned earlier can be determined. A person skilled in the art will be aware of various techniques for processing data obtained by the camera to determine the first distance. Alternatively or in addition, in some embodiments, the sensor 104 may comprise a distance and/or motion sensor positioned on the user (e.g. in or on gloves worn by the user) and the processor 102 can be configured to process data obtained by the distance and/or motion sensor to determine the first distance, such as by detecting passive or active markers on the joints along the limb of the user. For example, in some embodiments, the distance and/or motion sensor may be used to locate the joints along the limb (or the part of the limb) of the user. From the locations of the joints, the angles and lengths of the parts of the limb of the user mentioned earlier can be determined. A person skilled in the art will be aware of various techniques for processing data obtained by the distance and/or motion sensor to determine the first distance.

Returning back to FIG. 2, at block 204 of FIG. 2, a first surface is defined in the augmented and/or virtual reality environment at the determined first distance. More specifically, the processor 102 of the apparatus 100 defines the first surface in the augmented and/or virtual reality environment at the determined first distance. The first surface is defined by a rotation at a joint located at the proximal end or the distal end of the limb (or the part of the limb) of the user.

In some embodiments where the limb is an arm of the user and the first body part located at the distal end of the limb is a palm of a hand of the user or a fingertip of the hand of the user, the joint may comprise a shoulder joint of the user or a wrist joint of the user. Thus, in some embodiments, the first surface may be defined by a rotation at a shoulder joint located at the proximal end of the limb of the user or a wrist joint located at the distal end of the limb of the user. In some embodiments where the part of the limb is a forearm of the user and the first body part located at the distal end of the part of the limb is a palm of a hand of the user or a fingertip of the hand of the user, the joint may comprise an elbow joint of the user or a wrist joint of the user. Thus, in some embodiments, the first surface may be defined by a rotation at an elbow joint located at the proximal end of the part of the limb of the user or a wrist joint located at the distal end of the part of the limb of the user.

In some embodiments where the limb is a leg of the user and the first body part located at the distal end of the limb may be a sole of a foot of the user or a toe tip of the foot of the user, the joint may comprise a hip joint of the user or an ankle joint of the user. Thus, in some embodiments, the first surface may be defined by a rotation at a hip joint located at the proximal end of the limb of the user or an ankle joint located at the distal end of the limb of the user. In some embodiments where the part of the limb is a lower leg of the user and the first body part located at the distal end of the part of the limb may be a sole of a foot of the user or a toe tip of the foot of the user, the joint may comprise a knee joint of the user or an ankle joint of the user. Thus, in some embodiments, the first surface may be defined by a rotation at a knee joint located at the proximal end of the part of the limb of the user or an ankle joint located at the distal end of the part of the limb of the user.

In some embodiments, the rotation at the joint may be detected by a sensor 104. Thus, in some embodiments, the processor 102 may be configured to define the first surface in the augmented and/or virtual reality environment at the determined first distance based on the rotation at the joint detected by the sensor 104. The sensor 104 can thus be configured to detect rotation at the joint in some embodiments. As described earlier, the apparatus 100 may comprise the sensor 104 or the sensor 104 may be external to (i.e. separate to or remote from) the apparatus 100. In some embodiments, the sensor 104 can comprise a motion sensor (e.g. a camera), or any other sensor, or any combination of sensors, suitable for detecting rotation at the joint.

In some embodiments, the first surface may exclude a portion that is unreachable by the rotation. In this way, the portion of the first surface that the user is unable to reach (e.g. located behind the user) by rotation at the joint located at the proximal end or the distal end of the limb (or the part of the limb) of the user can be eliminated. It can thus be ensured that the first visual representation can be rendered at an ergonomically handy position for the user. In some embodiments, the portion of the first surface that is excluded may take into account physiological limitations of the user, e.g. by calibrating with a limb (or part of the limb) movement limitation of the user. In other embodiments, it may be assumed that the user can turn around and thus the entire first surface may be used.

Returning back to FIG. 2, at block 206 of FIG. 2, the first visual representation is rendered at a first position on the defined first surface in the augmented and/or virtual reality environment. More specifically, the processor 102 of the apparatus 100 renders the first visual representation at the first position on the defined first surface in the augmented and/or virtual reality environment. The first position can be referred to as an initial first position. For example, the first position refers to the spatial setting of the first visual representation when the user begins an application in the augmented and/or virtual reality environment. In some embodiments, the processor 102 may be configured to render the first visual representation by being configured to render a front surface of the first visual representation tangential to the defined first surface in the augmented and/or virtual reality environment. In this way, it can be ensured that the front surface of the first visual representation is made visible to the user.

In some embodiments, the processor 102 may be configured to render the first visual representation by being configured to control the user interface 110 to render the first visual representation at the first position on the defined first surface in the augmented and/or virtual reality environment. As described earlier, the apparatus 100 may comprise the user interface 110 or the user interface 110 may be external to (i.e. separate to or remote from) the apparatus 100. The first visual representation may, for example, comprise any one or more of a one dimensional (1D) visual representation, a two dimensional (2D) visual representation, a three dimensional (3D) visual representation, and any other dimensional visual representation. In some embodiments where more than one first visual representation is rendered on the defined first surface in the augmented and/or virtual reality environment, the first visual representations may be marked according to the ease with which the user can interact with them. For example, first visual representations that are in front of the user are easier for the user to interact with than those that are to the side of the user.

Although not illustrated in FIG. 2, in some embodiments, the processor 102 may also be configured to detect a motion gesture of the user. In these embodiments, a body part used for the detected motion gesture of the user may be the first body part located at the distal end of the limb (or the part of the limb). In some embodiments, the processor 102 may be configured to receive an input to displace the rendered first visual representation from the first position on the defined first surface to a first subsequent position in the augmented and/or virtual reality environment and render the first visual representation at the subsequent first position. In this way, the user is able to move the first visual representation to another position on the defined first surface or even to a position that is farther away from the user or closer to the user.

For example, if the user initially begins with their arm at full length and the surface on which the first visual representation is rendered is defined while the arm of the user is at full length, the user may later wish for the first visual representation to be brought closer to their body, such that they may bend their arm for comfort whilst still interacting with the first visual representation (since continually interacting with a visual representation at a fully extended arm length can become tiring), or for the user to perform richer or finer interactions with the first visual representation, or where the first visual representation is of interest to the user or the most useful. On the other hand, for example, the user may later wish for the first visual representation to be displaced farther away from their body when it is not of interest to the user or is the least useful.

In some embodiments, a motion gesture of the user may correspond to an operation on the first visual representation. For example, in some embodiments, moving a limb (or the part of the limb) past the first position of the first visual representation may correspond to selection of the first visual representation or some other operation on the first visual representation. On the other hand, in some embodiments, a motion gesture of the user moving a limb (or the part of the limb) toward their body from the first position of the first visual representation may correspond to a different operation on the first visual representation.

Although also not illustrated in FIG. 2, in some embodiments, the processor 102 may be configured to determine the first distance and define the first surface for at least two limbs (or at least two parts of the limbs) of the user. For example, the processor 102 may be configured to determine the first distance and define the first surface for at least two of a right arm of the user, a left arm of the user, a right leg of the user, and a left leg of the user. That is, for at least two limbs (or at least two parts of the limbs) of the user, the processor 102 can be configured to determine first distances from the proximal end of the respective limbs (or respective parts of the limbs) of the user to the first body part located at the distal end of the respective limbs (or respective parts of the limbs) of the user and define first surfaces in the augmented and/or virtual reality environment at the determined first distances, where the first surfaces are defined by the rotation at the joint located at the proximal end or the distal end of the respective limbs (or respective parts of the limbs) of the user. Thus, in effect, two or more first surfaces can be defined in the augmented and/or virtual reality environment according to some embodiments. In some of these embodiments, the processor 102 may be configured to render the first visual representation at a first position on at least one of the defined first surfaces in the augmented and/or virtual reality environment.

Although also not illustrated in FIG. 2, in some embodiments, in addition to the processor 102 being configured to determine the first distance, the processor 102 may also be configured to determine a second distance from the proximal end of the limb (or the part of the limb) of the user to a second body part located at the distal end of the limb (or the part of the limb) of the user. The second distance is less than the first distance. For example, in embodiments where the limb is an arm of the user, the second body part located at distal end of the limb may comprise a wrist joint of the user (e.g. rather than the palm of the hand located at the distal end of the arm or the fingertip of the hand located at the distal end of the arm). In embodiments where the part of the limb is a forearm of the user, the second body part located at distal end of the part of the limb may comprise a wrist joint of the user (e.g. rather than the palm of the hand located at the distal end of the forearm or the fingertip of the hand located at the distal end of the forearm).

Similarly, for example, in embodiments where the limb is a leg of the user, the second body part located at distal end of the limb may comprise an ankle joint of the user (e.g. rather than a sole of a foot located at the distal end of the leg or a toe tip of the foot located at the distal end of the leg). In embodiments where the part of the limb is a lower leg of the user, the second body part located at distal end of the part of the limb may comprise an ankle joint of the user (e.g. rather than a sole of a foot located at the distal end of the lower leg or a toe tip of the foot located at the distal end of the lower leg).

In some embodiments (e.g. where the limb of the user is fully extended), the processor 102 can be configured to determine the second distance by being configured to measure a straight line from the proximal end of the limb (or the part of the limb) of the user to the second body part located at the distal end of the limb (or the part of the limb) of the user. For example, in embodiments where the limb is an arm of the user and the second body part located at the distal end of the limb is a wrist joint of the user, the processor 102 can be configured to determine the second distance by being configured to measure a straight line from the proximal end of the arm of the user to the wrist joint located at the distal end of the arm. In embodiments where the part of the limb is a forearm of the user and the second body part located at the distal end of the part of the limb is a wrist joint of the user, the processor 102 can be configured to determine the second distance by being configured to measure a straight line from the proximal end of the forearm of the user to the wrist joint located at the distal end of the forearm.

Similarly, for example, in embodiments where the limb is a leg of the user and the second body part located at the distal end of the limb is an ankle joint of the user, the processor 102 can be configured to determine the second distance by being configured to measure a straight line from the proximal end of the leg of the user to the ankle joint located at the distal end of the leg. In embodiments where the part of the limb is a lower leg of the user and the second body part located at the distal end of the part of the limb is an ankle joint of the user, the processor 102 can be configured to determine the second distance by being configured to measure a straight line from the proximal end of the lower leg of the user to the ankle joint located at the distal end of the lower leg.

In other embodiments (e.g. where the limb of the user is in a resting position, such as where the limb of the user is at least partially bent), the processor 102 can be configured to determine the second distance by being configured to measure an angle at a plurality of joints along the limb (or the part of the limb) of the user. In some embodiments, the second distance may be determined by measuring an angle at a plurality of joints along the limb of the user and the lengths of the parts of the limb of the user (e.g. the lengths of the forearm and upper arm where the limb is an arm or the lengths of the lower leg and upper leg where the limb is a leg) and using geometric formulas. For example, the geometric formulas may be the law of cosines. A person skilled in the art will be aware of the manner in which the second distance may be determined using such geometric formulas. In some embodiments, an angle at a plurality of joints along the limb (or the part of the limb) of the user may be taken into account in the measurement of the second distance where the posture of the user changes, e.g. where a posture of the user becomes uncomfortable or the user loses balance.

In embodiments where the limb is an arm of the user, for example, the one or more joints along the limb of the user may be any one or more of the shoulder joint, the elbow joint, and the wrist joint. In embodiments where the part of the limb is a forearm of the user, for example, the one or more joints along the part of the limb of the user may be any one or more of the elbow joint and the wrist joint. Similarly, in embodiments where the limb is a leg of the user, for example, the one or more joints along the limb of the user may be any one or more of the hip joint, the knee joint, and the ankle joint. In embodiments where the part of the limb is a lower leg of the user, for example, the one or more joints along the part of the limb of the user may be any one or more of the knee joint and the ankle joint.

In yet other embodiments, the processor 102 can be configured to determine the second distance by being configured to measure a position of the second body part located at the distal end of the limb (or the part of the limb) of the user. As mentioned earlier, where the limb is an arm (or the part of the limb is a forearm) of the user, the second body part located at the distal end of the limb (or the part of the limb) may be a wrist joint of the user. Thus, in some embodiments, the processor 102 can be configured to determine the second distance by being configured to measure a position of the wrist joint located at the distal end of the arm (or the forearm). As also mentioned earlier, where the limb is a leg of the user (or the part of the limb is the lower leg), the second body part located at the distal end of the limb (or the part of the limb) may be an ankle joint of the user. Thus, in some embodiments, the processor 102 can be configured to determine the second distance by being configured to measure a position of the ankle joint located at the distal end of the leg (or the lower leg).

A person skilled in the art will be aware of various mechanisms by which the second distance can be determined. That is, for example, a person skilled in the art will be aware of various mechanisms by which a straight line from the proximal end of the limb (or the part of the limb) of the user to the second body part located at the distal end of the limb (or the part of the limb) of the user can be measured, an angle at a plurality of joints along the limb (or the part of the limb) of the user can be measured, and/or a position of the second body part located at the distal end of the limb (or the part of the limb) of the user can be measured (e.g. any of those described earlier in respect of the first distance).

In embodiments where the second distance is determined, the processor 102 may also be configured to define a second (or inner) surface in the augmented and/or virtual reality environment at the determined second distance. The second surface is defined by the rotation at the joint located at the proximal end of the limb (or the part of the limb) of the user or distal end of the limb (or the part of the limb) of the user. In some embodiments where the limb is an arm of the user and the second body part located at the distal end of the limb is a wrist joint of the user, the joint located at the proximal end of the limb of the user may comprise the shoulder joint of the user or the joint located at the distal end of the limb of the user may comprise the wrist joint of the user. In some embodiments where the part of the limb is an arm of the user and the second body part located at the distal end of the part of the limb is a wrist joint of the user, the joint located at the proximal end of the part of the limb of the user may comprise the knee joint of the user or the joint located at the distal end of the part of the limb of the user may comprise the wrist joint of the user.

Similarly, in some embodiments where the limb is a leg of the user and the second body part located at the distal end of the limb is an ankle joint of the user, the joint located at the proximal end of the limb of the user may comprise the hip joint of the user or the joint located at the distal end of the limb of the user may comprise the ankle joint of the user. In some embodiments where the part of the limb is a lower leg of the user and the second body part located at the distal end of the part of the limb is an ankle joint of the user, the joint located at the proximal end of the part of the limb of the user may comprise the knee joint of the user or the joint located at the distal end of the part of the limb of the user may comprise the ankle joint of the user. In the manner described earlier in respect of the first surface, for the second surface, the rotation at the joint located at the proximal end of the limb (or the part of the limb) of the user or distal end of the limb (or the part of the limb) of the user may be detected by the sensor 104.

In embodiments where the second surface is defined, the processor 102 can be configured to render at least one other visual (or virtual) representation at a second position on the defined second surface in the augmented and/or virtual reality environment. The at least one other visual representation rendered at the second position will be referred to as a second visual (or virtual) representation. The second position can be referred to as an initial second position. For example, the second position refers to the spatial setting of the second visual representation when the user begins an application in the augmented and/or virtual reality environment. In some embodiments, the processor 102 may be configured to render the second visual representation by being configured to render a front surface of the second visual representation tangential to the defined second surface in the augmented and/or virtual reality environment. In this way, it can be ensured that the front surface of the second visual representation is made visible to the user.

In some embodiments, the second surface may exclude a portion that is unreachable by the rotation. In this way, the portion of the second surface that the user is unable to reach (e.g. located behind the user) by rotation at the joint located at the proximal end or distal end of the limb (or the part of the limb) of the user can be eliminated. It can thus be ensured that the second visual representation can be rendered at an ergonomically handy position for the user. In some embodiments, the portion of the second surface that is excluded may take into account physiological limitations of the user, e.g. by calibrating with a limb (or a part of the limb) movement limitation of the user. In other embodiments, it may be assumed that the user can turn around and thus the entire second surface may be used.

In some embodiments, the processor 102 may be configured to render the second visual representation by being configured to control the user interface 110 to render the second visual representation at the second position on the defined second surface in the augmented and/or virtual reality environment. As described earlier, the apparatus 100 may comprise the user interface 110 or the user interface 110 may be external to (i.e. separate to or remote from) the apparatus 100. The second visual representation may, for example, comprise any one or more of a one dimensional (1D) visual representation, a two dimensional (2D) visual representation, a three dimensional (3D) visual representation, and any other dimensional visual representation. In some embodiments where more than one second visual representation is rendered on the defined second surface in the augmented and/or virtual reality environment, the second visual representations may be marked according to the ease with which the user can interact with them. For example, second visual representations that are in front of the user are easier for the user to interact with than those that are to the side of the user.

In some embodiments, the processor 102 may be configured to detect a motion gesture of the user. In these embodiments, a body part used for the detected motion gesture of the user may be the first and/or second body part located at the distal end of the limb (or the part of the limb). In some embodiments, the processor 102 may be configured to receive an input to displace the rendered second visual representation from the second position on the defined second surface to a subsequent second position in the augmented and/or virtual reality environment and render the second visual representation at the subsequent second position.

In some embodiments, the processor 102 may be configured to determine the second distance and define the second surface for at least two limbs (or at least two parts of the limbs) of the user. For example, the processor 102 may be configured to determine the second distance and define the second surface for at least two of a right arm of the user, a left arm of the user, a right leg of the user, and a left leg of the user. That is, for at least two limbs or at least two parts of the limbs) of the user, the processor 102 can be configured to determine second distances from the proximal end of the respective limbs (or the respective parts of the limbs) of the user to the body part located at the distal end of the respective limbs (or the respective parts of the limbs) of the user and define second surfaces in the augmented and/or virtual reality environment at the determined second distances, where the second surfaces are defined by the rotation at the joint located at the proximal end or the distal end of the respective limbs (or the respective parts of the limbs) of the user. Thus, in effect, two or more first surfaces can be defined in the augmented and/or virtual reality environment according to some embodiments. In some of these embodiments, the processor 102 may be configured to render the second visual representation at a second position on at least one of the defined second surfaces.

Although also not illustrated in FIG. 2, in some embodiments, in addition to the processor 102 being configured to determine the first distance and optionally also the second distance, the processor 102 may also be configured to determine a third distance from the proximal end of the limb (or the part of the limb) of the user. The third distance is the first distance plus a predefined additional distance. Thus, the third distance is greater than the first distance. The third distance is also greater than the second distance. In embodiments where the third distance is determined, the processor 102 may also be configured to define a third (or outer) surface in the augmented and/or virtual reality environment at the determined third distance. The third surface is defined by the rotation at the joint located at the proximal end of the limb (or the part of the limb) of the user or distal end of the limb (or the part of the limb) of the user.

In embodiments where the third surface is defined, the processor 102 can be configured to render at least one other visual (or virtual) representation at a third position on the defined third surface in the augmented and/or virtual reality environment. The at least one other visual representation rendered at the third position will be referred to as a third visual (or virtual) representation. The third position can be referred to as an initial third position.

For example, the third position refers to the spatial setting of the third visual representation when the user begins an application in the augmented and/or virtual reality environment. In some embodiments, the processor 102 may be configured to render the third visual representation by being configured to render a front surface of the third visual representation tangential to the defined third surface in the augmented and/or virtual reality environment. In this way, it can be ensured that the front surface of the third visual representation is made visible to the user.

In some embodiments, like the first surface, the third surface may exclude a portion that is unreachable by the rotation. In this way, the portion of the third surface that the user is unable to reach (e.g. located behind the user) by rotation at the joint located at the proximal end or distal end of the limb (or the part of the limb) of the user can be eliminated. It can thus be ensured that the third visual representation can be rendered at an ergonomically handy position for the user. In some embodiments, the portion of the third surface that is excluded may take into account physiological limitations of the user, e.g. by calibrating with a limb (or a part of the limb) movement limitation of the user. In other embodiments, it may be assumed that the user can turn around and thus the entire third surface may be used.

In some embodiments, the processor 102 may be configured to render the third visual representation by being configured to control the user interface 110 to render the third visual representation at the third position on the defined third surface in the augmented and/or virtual reality environment. As described earlier, the apparatus 100 may comprise the user interface 110 or the user interface 110 may be external to (i.e. separate to or remote from) the apparatus 100. The third visual representation may, for example, comprise any one or more of a one dimensional (1D) visual representation, a two dimensional (2D) visual representation, a three dimensional (3D) visual representation, and any other dimensional visual representation. In some embodiments where more than one third visual representation is rendered on the defined third surface in the augmented and/or virtual reality environment, the third visual representations may be marked according to the ease with which the user can interact with them. For example, third visual representations that are in front of the user are easier for the user to interact with than those that are to the side of the user.

In some embodiments, the processor 102 may be configured to detect a motion gesture of the user. In these embodiments, a body part used for the detected motion gesture of the user may be the first and/or second body part located at the distal end of the limb (or the part of the limb). In some embodiments, the processor 102 may be configured to receive an input to displace the rendered third visual representation from the third position on the defined third surface to a subsequent third position in the augmented and/or virtual reality environment and render the third visual representation at the subsequent third position.

In some embodiments, the processor 102 may be configured to determine the third distance and define the third surface for at least two limbs (or at least two parts of the limbs) of the user. For example, the processor 102 may be configured to determine the third distance and define the third surface for at least two of a right arm of the user, a left arm of the user, a right leg of the user, and a left leg of the user. That is, for at least two limbs (or at least two parts of the limbs) of the user, the processor 102 can be configured to determine third distances from the proximal end of the respective limbs (or the respective parts of the limbs) of the user to the body part located at the distal end of the respective limbs (or the respective parts of the limbs) of the user and define third surfaces in the augmented and/or virtual reality environment at the determined third distances, where the third surfaces are defined by the rotation at the joint located at the proximal end or the distal end of the respective limbs (or the respective parts of the limbs) of the user. Thus, in effect, two or more third surfaces can be defined in the augmented and/or virtual reality environment according to some embodiments. In some of these embodiments, the processor 102 may be configured to render the third visual representation at a third position on at least one of the defined third surfaces.

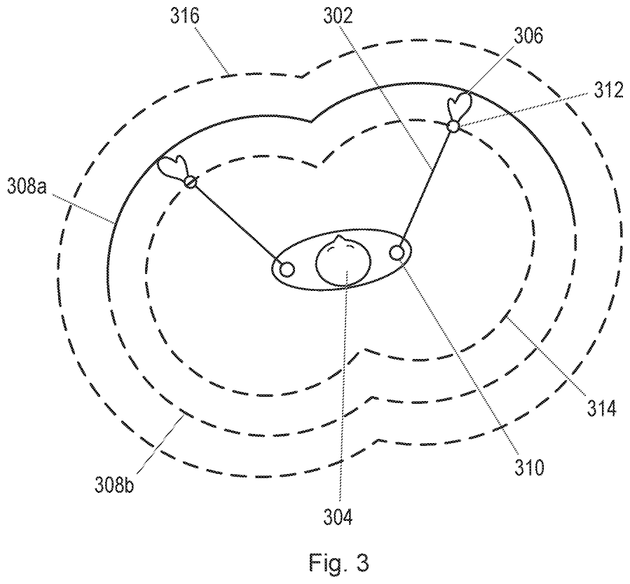

FIG. 3 is a schematic illustration of an augmented and/or virtual reality environment according to an embodiment. The computer-implemented method 200 of FIG. 2 for rendering one or more visual representations in an augmented and/or virtual reality environment will now be described with reference to the embodiment illustrated in FIG. 3.

As described earlier, at block 202 of FIG. 2, a first distance from a proximal end of a limb of a user to a first body part located at a distal end of the limb of the user is determined. In the embodiment illustrated in FIG. 3, the limb is an arm 302 of the user 304 and the arm 302 is fully extended. The first body part located at the distal end of the arm 302 is a fingertip 306 of the hand of the user 304. Thus, in the embodiment illustrated in FIG. 3, the first distance is from a proximal end of the arm 302 of the user 304 to the fingertip 306 of the hand located at the distal end of the arm 302 of the user 304. In the embodiment illustrated in FIG. 3, the processor 102 is configured to determine the first distance by being configured to measure a straight line from the proximal end of the arm 302 of the user 304 to the fingertip 306 of the hand located at the distal end of the arm 302 of the user 304.

As described earlier, at block 204 of FIG. 2 and as illustrated in FIG. 3, a first surface 308a is defined in the augmented and/or virtual reality environment at the determined first distance. As illustrated in FIG. 3, in this embodiment, the first surface 308a is defined by a rotation at a shoulder joint 310 located at the proximal end of the arm 302 of the user 304. In the embodiment illustrated in FIG. 3, the first surface 308a excludes a portion 308b that is unreachable by the rotation. As described earlier, at block 206 of FIG. 2, the first visual representation (not illustrated in FIG. 3) is rendered at a first position on the defined first surface 308a in the augmented and/or virtual reality environment. In the illustrated embodiment of FIG. 3, the processor 102 is configured to determine the first distance and define the first surface 308a for two limbs of the user, namely both arms 302 of the user 304. Thus, the first visual representation can be rendered at a first position on at least one of the defined first surfaces 308a in the augmented and/or virtual reality environment.

The embodiment illustrated in FIG. 3, where the first visual representation is rendered at a first position optimal for the user to reach with their arm in a fully extended position, may be useful in a situation where there are many visual representations and/or three dimensional visual representation (since more space is available with the arm in a fully extended position compared to a resting position), the user is standing, and/or the first interactions need to be performed quickly (since extending the arm fully is faster than placing the arm in a resting position).

In the illustrated embodiment of FIG. 3, in addition to the processor 102 being configured to determine the first distance, the processor 102 may also be configured to determine a second distance from the proximal end of the limb of the user to a second body part located at the distal end of the limb of the user. In the example embodiment of FIG. 3, the second body part is the wrist joint 312 located at the distal end of the arm 302 of the user 304. Thus, as illustrated in FIG. 3, the second distance is less than the first distance. In the embodiment illustrated in FIG. 3, the processor 102 is configured to determine the second distance by being configured to measure a straight line from the proximal end of the arm 302 of the user 304 to the wrist joint 312 located at the distal end of the arm 302 of the user 304.

As described earlier and as illustrated in FIG. 3, a second surface 314 is defined in the augmented and/or virtual reality environment at the determined second distance. As illustrated in FIG. 3, in this embodiment, the second surface 314 is defined by the rotation at the shoulder joint 310 located at the proximal end of the arm 302 of the user 304. As with the first surface, in some embodiments, the second surface 314 may exclude a portion that is unreachable by the rotation. As described earlier, a second visual representation (not illustrated in FIG. 3) can be rendered at a second position on the defined second surface 314 in the augmented and/or virtual reality environment. In the illustrated embodiment of FIG. 3, the processor 102 can be configured to determine the second distance and define the second surface 314 for two limbs of the user, namely both arms 302 of the user 304, such that the defined second surface 314 is a combination of two curved surfaces. Thus, the second visual representation can be rendered at a second position on at least one of these two curved surfaces in the augmented and/or virtual reality environment. The second surface 314 may, for example, be useful for visual representations that require more complex/whole hand interaction (e.g. grab and rotate, pinch and expand).

In the illustrated embodiment of FIG. 3, in addition to the processor 102 being configured to determine the first distance and optionally also the second distance, the processor 102 may also be configured to determine a third distance from the proximal end of the limb of the user. As described earlier, the third distance is the first distance plus a predefined additional distance (or offset). As illustrated in the embodiment of FIG. 3, the processor 102 can be configured to define a third surface 316 in the augmented and/or virtual reality environment at the determined third distance. In the embodiment illustrated in FIG. 3, the third surface 316 is defined by the rotation at the shoulder joint 312 located at the proximal end of the arm 302 of the user 304. As with the first surface, in some embodiments, the third surface 316 may exclude a portion that is unreachable by the rotation.

As described earlier, a third visual representation (not illustrated in FIG. 3) can be rendered at a third position on the defined third surface 316 in the augmented and/or virtual reality environment. In the illustrated embodiment of FIG. 3, the processor 102 can be configured to determine the third distance and define the third surface 316 for two limbs of the user, namely both arms 302 of the user 304, such that the defined third surface 316 is a combination of two curved surfaces. Thus, the third visual representation can be rendered at a third position on at least one of these two curved surfaces in the augmented and/or virtual reality environment. The third surface 316 may be useful, for example, for placing visual representations that are out of reach initially and thus cannot be accidentally activated, but can be easily be reached by the user slightly leaning toward them.

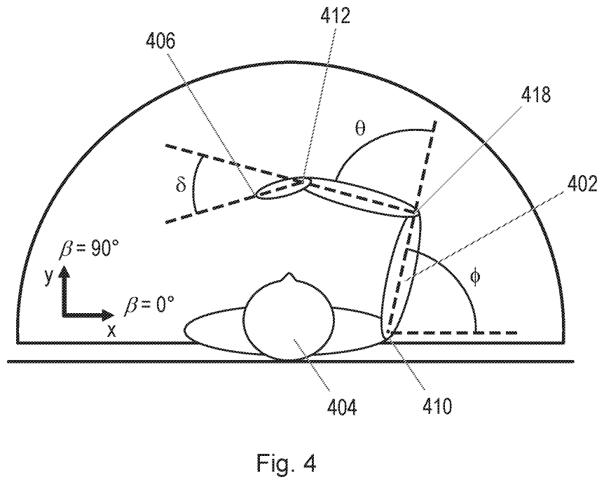

FIG. 4 is a schematic illustration of an augmented and/or virtual reality environment according to another embodiment. The computer-implemented method 200 of FIG. 2 for rendering one or more visual representations in an augmented and/or virtual reality environment will now be described with reference to the embodiment illustrated in FIG. 4.

As described earlier, at block 202 of FIG. 2, a first distance from a proximal end of a limb of a user to a first body part located at a distal end of the limb of the user is determined. In the embodiment illustrated in FIG. 4, the limb is an arm 402 of the user 404 and the arm 402 is in a resting position (e.g. at least partially bent). The first body part located at the distal end of the arm 402 is a fingertip 406 of the hand of the user 404. Thus, in the embodiment illustrated in FIG. 4, the first distance is from a proximal end of an arm 402 of the user 404 to the fingertip 406 of the hand located at the distal end of the arm 402 of the user 404. In the embodiment illustrated in FIG. 4, the processor 102 is configured to determine the first distance by being configured to determine the first distance by being configured to measure an angle (ϕ, δ, θ) at a plurality of joints 410, 412, 418 along the arm 402 of the user 404. In the embodiment illustrated in FIG. 4, the one or more joints along the arm 402 of the user 404 include the shoulder joint 410, the wrist joint 412, and the elbow joint 418.

In some embodiments, the first distance may be determined by measuring an angle (ϕ, δ, θ) at a plurality of joints 410, 412, 418 along the arm 402 of the user 404 and the lengths of the parts of the arm 402 (that is, the lengths of the forearm and upper arm) of the user 404 and using geometric formulas. For example, the geometric formulas may be the law of cosines. A person skilled in the art will be aware of the manner in which the first distance may be determined using such geometric formulas.

In an embodiment, for example, a distance between the shoulder joint 410 and the wrist joint 406 of the arm 402 of the user 404 may be determined based on the angle θ at the elbow joint 418 and the lengths of the forearm and upper arm using geometric formulas, such as the law of cosines. Effectively, the distance between the shoulder joint 410 and the wrist joint 406 of the arm 402 of the user 404 forms a third side of a triangle, with the forearm and the upper arm being the other two sides of the triangle. The first distance from the proximal end 410 of the arm 402 of the user 404 to the fingertip 406 of the hand located at a distal end of the arm 402 of the user 404 can then be determined from the determined distance between the shoulder joint 410 and the wrist joint 406 of the arm 402, the angle δ at the wrist joint 406, and the length of the hand using geometric formulas, such as the law of cosines. Effectively, the first distance forms a third side of a triangle, with the hand and the distance between the shoulder joint 410 and the wrist joint 406 of the arm 402 of the user 404 being the other two sides of the triangle.

Although not illustrated in FIG. 4, the second distance from the proximal end of the arm 402 of the user 404 to a second body part (e.g. the wrist joint) located at the distal end of the arm 402 of the user 404 may be determined in a similar manner to that described with reference to FIG. 4 for determining the first distance. As described earlier, at block 204 of FIG. 2, a first surface (not illustrated in FIG. 4) is defined in the augmented and/or virtual reality environment at the determined first. In this embodiment, the first surface is defined by a rotation at a shoulder joint 410 located at the proximal end of the arm 402 of the user 404. As described earlier, at block 206 of FIG. 2, a first visual representation (not illustrated in FIG. 4) is rendered at a first position on the defined first surface in the augmented and/or virtual reality environment.

The embodiment illustrated in FIG. 4, where the first visual representation is rendered at a first position optimal for the user to reach with their arm in a resting position, may be useful in a situation where the user has physical limitations and/or where the first interaction needs to be performed using fine gestures.

There is also provided a computer program product comprising a non-transitory computer readable medium. The computer readable medium has computer readable code embodied therein. The computer readable code is configured such that, on execution by a suitable computer or processor, the computer or processor is caused to perform the method as described herein. Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or apparatus may be sub-divided into one or more sub-routines. Many different ways of distributing the functionality among these sub-routines will be apparent to the skilled person. The sub-routines may be stored together in one executable file to form a self-contained program. Such an executable file may include computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also include function calls to each other.

An embodiment relating to a computer program product includes computer-executable instructions corresponding to each processing stage of at least one of the methods set forth herein. These instructions may be sub-divided into sub-routines and/or stored in one or more files that may be linked statically or dynamically. Another embodiment relating to a computer program product includes computer-executable instructions corresponding to each means of at least one of the apparatus and/or products set forth herein. These instructions may be sub-divided into sub-routines and/or stored in one or more files that may be linked statically or dynamically.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

There is thus provided herein an apparatus, method, and computer program product that address the limitations associated with the existing techniques. The apparatus, method, and computer program product can be useful in a variety of applications, such as in the exploration of virtual body maps for user education and guidance (e.g. an initial virtual body representation may be located at full arm's length and the user can bring (parts of) the virtual body representation closer to get more information or more details or to zoom in), in a virtual workstation (e.g. virtual window representations may initially be located at optimal arm position and the user can reorder the position of the virtual window representations around them, bring virtual window representations closer to or farther away from them, or discard virtual window representations), in physical rehabilitation (e.g. a virtual object representations may be located at user's arm/leg length at various positions, the user may be required to reach the virtual object representations to train certain movements, and the position of the virtual object representations may be adapted over time when the user is able to extend their arm/leg more), and so on.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An apparatus for rendering one or more visual representations in an augmented and/or virtual reality environment, the apparatus comprising:
a processor configured to:
determine a first distance from a proximal end of a limb or a part of the limb of a user to a first body part located at a distal end of the limb or the part of the limb of the user;
define a first surface in the augmented and/or virtual reality environment at the determined first distance, wherein the first surface is defined by a rotation at a joint located at the proximal end or the distal end of the limb or the part of the limb of the user; and
render a visual representation at a first position on the defined first surface in the augmented and/or virtual reality environment.

2. An apparatus as claimed in claim 1, wherein:
the limb is an arm of the user, the first body part located at the distal end of the limb is a palm of a hand of the user or a fingertip of the hand of the user and the joint comprises a shoulder joint of the user or a wrist joint of the user; or
the part of the limb is a forearm of the user, the first body part located at the distal end of the part of the limb is a palm of a hand of the user or a fingertip of the hand of the user and the joint comprises an elbow joint of the user or a wrist joint of the user; or
the limb is a leg of the user, the first body part located at the distal end of the limb is a sole of a foot of the user or a toe tip of the foot of the user and the joint comprises a hip joint of the user or an ankle joint of the user; or
the part of the limb is a lower leg of the user, the first body part located at the distal end of the part of the limb is a sole of a foot of the user or a toe tip of the foot of the user and the joint comprises a knee joint of the user or an ankle joint of the user.

3. An apparatus as claimed in claim 1, wherein the rotation at the joint is detected by a sensor.

4. An apparatus as claimed in claim 1, wherein the processor is configured to determine the first distance by being configured to measure:
a straight line from the proximal end of the limb or the part of the limb of the user to the first body part located at the distal end of the limb or the part of the limb of the user;
an angle at a plurality of joints along the limb or the part of the limb of the user; and/or
a position of the first body part located at the distal end of the limb or the part of the limb of the user.

5. An apparatus as claimed in claim 1, wherein the processor is configured to:
detect a motion gesture of the user,
wherein a body part used for the detected motion gesture of the user is the first body part located at the distal end of the limb or the part of the limb.

6. An apparatus as claimed in claim 1, wherein the first surface excludes a portion that is unreachable by the rotation.

7. An apparatus as claimed in claim 1, wherein the processor is configured to render the visual representation by being configured to:
render a front surface of the visual representation tangential to the defined first surface in the augmented and/or virtual reality environment.

8. An apparatus as claimed in claim 1, wherein the processor is configured to:
determine the first distance and define the first surface for at least two limbs or at least two parts of the limbs of the user; and
render the visual representation at a first position on at least one of the defined first surfaces in the augmented and/or virtual reality environment.

9. An apparatus as claimed in claim 1, wherein the processor is configured to:
receive an input to displace the rendered visual representation from the first position on the defined first surface to a subsequent position in the augmented and/or virtual reality environment; and
render the visual representation at the subsequent position.

10. An apparatus as claimed in claim 1, wherein the processor is configured to:
determine a second distance from the proximal end of the limb or the part of the limb of the user to a second body part located at the distal end of the limb or the part of the limb of the user, wherein the second distance is less than the first distance;
define a second surface in the augmented and/or virtual reality environment at the determined second distance, wherein the second surface is defined by the rotation at the joint located at the proximal end of the limb or the part of the limb of the user or distal end of the limb or the part of the limb of the user; and
render at least one other visual representation at a second position on the defined second surface in the augmented and/or virtual reality environment.

11. An apparatus as claimed in claim 10, wherein:
the limb is an arm of the user, the second body part located at distal end of the limb comprises a wrist joint of the user and the joint comprises a shoulder joint of the user or the wrist joint of the user; or
the part of the limb is a forearm of the user, the second body part located at distal end of the part of the limb comprises a wrist joint of the user and the joint comprises an elbow joint of the user or the wrist joint of the user; or
the limb is a leg of the user, the second body part located at distal end of the limb comprises an ankle joint of the user and the joint comprises a hip joint of the user or the ankle joint of the user; or
the part of the limb is a lower leg of the user, the second body part located at distal end of the part of the limb comprises an ankle joint of the user and the joint comprises a knee joint of the user or the ankle joint of the user.

12. An apparatus as claimed in claim 1, wherein the processor is configured to:
determine a third distance from the proximal end of the limb or the part of the limb of the user, wherein the third distance is the first distance plus a predefined additional distance;
define a third surface in the augmented and/or virtual reality environment at the determined third distance, wherein the third surface is defined by the rotation at the joint located at the proximal end of the limb or the part of the limb of the user or distal end of the limb or the part of the limb of the user; and
render at least one other visual representation at a third position on the defined third surface in the augmented and/or virtual reality environment.

13. An apparatus as claimed in claim 1, wherein the visual representation comprises any one or more of:
a one dimensional visual representation;
a two dimensional visual representation; and
a three dimensional visual representation.

14. A computer-implemented method for rendering one or more visual representations in an augmented and/or virtual reality environment, the method comprising:
determining a first distance from a proximal end of a limb or a part of the limb of a user to a first body part located at a distal end of the limb or the part of the limb of the user;
defining a first surface in the augmented and/or virtual reality environment at the determined first distance, wherein the first surface is defined by a rotation at a joint located at the proximal end or the distal end of the limb or the part of the limb of the user; and
rendering a visual representation at a first position on the defined first surface in the augmented and/or virtual reality environment.

15. A computer program product comprising a non-transitory computer readable medium, the computer readable medium having computer readable code embodied therein, the computer readable code being configured such that, on execution by a suitable computer or processor, the computer or processor is caused to perform the method of claim 14.
